(19) United States
(12) Patent Application Publication
(10) Pub. No.: US 2002/0186135 A1
(43) Pub. Date: Dec. 12, 2002

(54) Device for locating an individual

(76) Inventor: Colleen Wagner, Bensalem, PA (US)

Correspondence Address: Michael I. Kroll, 171 Stillwell Lane, Syosset, NY, 11791, US

(21) Appl. No.: 09/867,641

(22) Filed: May 30, 2001

(51) Int. Cl. G08B 23/00

(52) U.S. Cl. 340/573.1; 340/573.4; 340/539

(57) ABSTRACT

A system for locating an individual. The system includes a main unit for monitoring a predetermined area, a plurality of tracking units having a unique identification code and a plurality of activation units paired with a respective one of said tracking units, each pair having a unique identification code. The activation unit includes an activation button that is manually activated by a user upon desiring to determine a location of the tracking unit. Upon activation of the button a location request signal is transmitted to activate the main unit to determine a position of the tracking unit within the monitored area. The main unit relays a position signal indicating the determined position to the mobile hand held unit to aid in locating the tracking unit. The main unit includes a central station and a plurality of sensors strategically positioned about the monitored area in wireless communication with the central station. Each tracking unit and hand held unit include a sensor for activating a monitored area speaker to generate an audible alarm upon passage outside of the monitored area. Each activation unit includes a cover providing selective access to the activation button. Each tracking unit includes an illumination device for generating a visible signal upon receipt of the location signal from the main unit.

### BACKGROUND OF THE INVENTION

1. Field of the Invention

The present invention relates generally to location detection systems and, more specifically, to a system including a main terminal for monitoring a specific area such as a mall or park and individual tracking bracelets retained by individuals within the monitored area whereby, upon engaging the activation unit, the main unit can obtain the location of any one of the tracking bracelets and thereby determine the location of the individual wearing said tracking bracelet.

2. Description of the Prior Art

Numerous types of location monitoring systems have been provided in the prior art. For example, U.S. Pat. No. 4,694,284; 4,819,860; 4,885,571; 5,014,040; 5,021,794; 5,027,314; 5,196,825; 5,204,670; 5,334,974; 5,525,967; 5,661,492 and 5,929,777all are illustrative of such prior art. Furthermore, there have not been provided many location systems which have been able to monitor the location of a person or child within a public facility such as a park, mall, amusement park or nursing home. In these areas situations such as shown in FIG. 1 are common. This figure illustrates a mall area 10. Within the mall area 10 are numerous customers 12. The customers 12 are shopping at the stores located in the mall area 10. When a mall area 10 gets overcrowded with customers 12 such as during holiday seasons, it is difficult for a parent 16 to keep track of a child 18 who is able to wander off. When a child 18 wanders off, the parent 16 will have a difficult time attempting to find the child 18. In such instances, the parent 16 is normally seen wandering the mall area 10 screaming out and hoping the child 18 can hear her. Upon realizing the parent 16 is not within sight, the child 18, dependent upon the age, normally begins crying or shouting for the parent 16. This scenario continues until the child 18 and parent 16 are reunited.

While these units may be suitable for the particular purpose to which they address, they would not be as suitable for the purposes of the present invention as heretofore described.

### U.S. Pat No. 4,694,284

### Inventor: Serge Leveille et al.

### Issue Date: Sep. 15, 1987

The collar consist of two legs pivoted to each other at one end by a hinge member and releasably locked to each other at the other end by a key operated lock. The legs are made of shear-resistant material. A radio signal generating and transmitting device and autonomous power supply are housed within the collar. A trigger switch is closed to activated the device upon opening of a flap by the abducted collar wearer, and circuitry including a silicon controlled rectifier caused activation of the transmitter and characterized by the impossibility of deactivation thereof, short of complete discharge of the power supply, as long as the lock locks the legs of the collar around the wrist, neck or ankle of the wearer.

### U.S. Pat. No. 4,819,860

### Inventor: James L. Hargrove et al.

### Issue Date: Apr. 11, 1989

A wrist-mounted pulse rate and body temperature monitor has means for storing upper and lower emergency pulse rates and body temperatures by means of which an emergency medical situation is defined. When the monitor detects an emergency medical situation, an emergency signal is generated on standard emergency locator frequencies to alert search and rescue services. Means for automatically setting the upper and lower safe thresholds is provided. The device is particularly suited for use by individuals in remote areas where either the health of the individual or the environment create a higher risk to the survival of the individual.

### U.S. Pat. No. 4,885,571

### Inventor: James D. Pauley et al.

### Issue Date: Dec. 5, 1989

A tag for use with an individual monitoring system. The tag is worn by an individual being monitored, preferably on the ankle or leg where it can be concealed by the clothing of the individual. The tag is fully self contained and sealed. The circuits of the tag periodically generate an identification signal that includes an identification code. The identification signal modulates a stable RF signal that is transmitted in bursts of data words to a receiver associated with a field monitoring device (FMD) located at the monitoring location. In turn, the FMD may randomly establish communication with a central processing unit (CPU) located at a central monitoring location. Other information is included in the identification code of the tag, such as information indicating that an attempt has been made to remove the tag from the individual. The tag is held in place near the skin of it's wearer by a conductive strap that wraps around the leg or other limb of the individual. Two capacitive electrodes, one of which is realized with the conductive strap, function as the plates of a capacitor, with the body flesh serving as the dielectric material therebetween. By monitoring an alternating signal coupled from one capacitive electrode to the other, a determination can be made as to whether the tag has remained near the body flesh. Further, because the strap is conductive, a signal can be passed therethrough and a determination can be made as to whether the strap has been broken.

### U.S. Pat. No. 5,014,040

### Inventor: Philip W. Weaver et al.

### Issue Date May 7, 1991

A personal locator transmitter adapted to be worn on the wrist and having the size and appearance of a conventional wrist-watch. This transmitter is provided with a programmed memory, a transmitter controlled by the memory, an antenna for reliably radiating signals from the transmitter regardless of of orientation of the wrist of a user and including both a manually operable alarm activated by pressing a button, and an automatic alarm actuated by an attempt to remove the unit from the wrist of the wearer. The unit is controlled by a control memory comprised of an EEPROM encoded with unique identification codes and other information as required in the specific application.

### U.S. Pat. No. 5,021,794

### Inventor: Robert A. Lawrence

### Issue Date: Jun. 4, 1991

The radio transmitter in a miniaturized transceiver concealed on a person to be located, such as a lost child, is activated and transmits a coded UHF radio homing signal upon receipt of an initiating signal containing the child's address code. The initiating signal is automatically transmitted by a repeater station in response to an audible “panic signal” containing the address code and contains the identical address code. The panic signal is a pulse tone produced by hand held tone generator activated by the child's parent and is transmitted to the repeater station by telephone. Tracking vehicles are provided with automatic UHF radio direction finding and distance measuring equipment for locating the source of the homing signal. Stored information concerning the child can be transmitted to the tracking vehicles.

### U.S. Pat. No. 5,027,314

### Inventor: Gary Linwood et al.

### Issue Date: Jun. 25, 1991

A system and method for tracking a number of subjects in a plurality of areas is shown to include a plurality of transmitters, wherein at least one transmitter is associated with each subject, each transmitter transmits a light based signal representative of an identifying code unique to that transmitter, a plurality of receivers, wherein at least one receiver is associated with each area, each receiver converts transmitted light based signals to electrical signals and validates the electrical signal to determine whether such electrical signals are representative of the unique identifying codes associated with the transmitters, and a central processing member, connected to each of the receivers, for recording those electrical signals which are representative of the unique identifying codes for recording the receiver which determined that such electrical signals are representative of the unique identifying codes associated with the transmitters and for determining in which area the transmitter is actually located.

### U.S. Pat. No. 5,196,825

### Inventor: James T. Young

### Issue Date: Mar. 23, 1993

An apparatus is provided for monitoring the location of a person and for determining whether the person is in distress. The apparatus includes a transmitter and a transceiver, which are adapted to be worn at different locations on the persons body. The transmitter normally transmits a first electromagnetic signal, which is detectable by the transceiver and by at least one remote receiver. When the person is in distress, the transmitter transmits a second electromagnetic signal in lieu of the first signal. The transceiver is responsive to the second signal for generating a third electromagnetic signal, which also indicates that the person is in distress. The remote receiver is responsive to either or both of the second and third signals for generating an alarm signal indicating the distress condition. The transceiver also generates the third signal in response to the absence of the first signal, which may occur when the transmitter is removed from the person's body and the distance between the transmitter and transceiver becomes too great for the transceiver to receive the first signal, or due to transmitter malfunctional. The third signal therefore provides a redundancy feature in the event of failure of the transmitter to generate the second signal. The apparatus not only allows the person's location to be continuously monitored, but also indicates when the person is in need of assistance.

### U.S. Pat. No. 5.204.670

### Inventor: Vincent D. Stinton

### Issue Date: Apr. 20, 1993

A personnel monitoring system includes a host central processing unit, or CPU, maintained by a supervising agency that automatically, or by request, receives and interprets data from individuals being monitored. The monitored individuals may wear or carry a transmitting or transponding unit that periodically, or upon request, transmits a uniquely encoded signal that identifies the person being monitored, as well as information about the condition or activities of the person being monitored. Lower risk monitored individuals may be required to simply contact the host CPU on a regular basis, e.g., weekly, monthly, or yearly. The host CPU includes a plurality of software submodules that can be selectively installed therein to allow a desired monitoring configuration to be used in order to best meet the needs of the monitoring agency. The communication link between the individual and the CPU may be by way of existing telephone lines or other telecommunicative links. From data received, the host CPU generates desired reports indicating the location, condition, status, and/or activities of the monitored individual.

### U.S. Pat. No. 5,334,974

### Inventor: James R. Simms et al.

### Issue Date Aug. 2, 1994

A fully automatic personnal security system which combines the advantages of worldwide LORAN-C or GPS navigation with the substantially worldwide communication capabilities of a cellular telephone or communication satellite. The security system comprises a mobile unit which communicates emergency data including position coordinates, and a central dispatch station which receives the emergency data and accurately displays all necessary emergency information superposed on a digitized map at a position corresponding to the location of the mobile unit.

### U.S. Pat. No. 5,525,967

### Inventor: S. Massoud Azizi, et al.

### Issue Date: Jun. 11, 1996

A system and method to monitor the specific location of a person, pet or item of personal property by employing elements that enable the user to pinpoint both the distance and the direction of the person or object being monitored relative to the position of the monitoring or transmission unit (the “source”), comprising a tracking transceiver unit, which tracks and monitors the person or object, and the target transceiver unit, which is worn or affixed to the person or object being monitored. The tracking transceiver unit broadcasts a signal to a target transceiver unit, which, upon receiving the signal, will then broadcast a response signal back to the tracking transceiver unit. The tracking transceiver unit's antenna, which comprises a plurality of flat sensor plate-like elements formed together in a generally spherical configuration, picks up the signal and then conveys the information it receives to a special response signal processor unit, which analyzes the data to determine the direction of the person or object being monitored. Information filtered and analyzed through the response signal processor unit is then conveyed to a central processor unit, which uses the data to calculate the distance of the person or object being monitored from the source.

### U.S. Pat. No. 5,661,492

### Inventor: Stephen Davis Shoap et al.

### Issue Date: Aug. 26, 1997

A population of located personal detection units (PDUs) (20) are worn by users. Any number of locators (14) are placed at known locations within an area (10) where the users tend to be. When an alarm event for an individual user occurs, a request signal is transmitted from the user's PDU (20). The request signal is received at several of the locators (14), each of which measure the power level of the request signal. A central computers (16) selects some of these locators (14) in response to the power level measurements. In sequence, the selected locators (14) transmit an interrogation signal to the PDU (20), the PDU (20) replies to the interrogation signal, and the locators (14) measure the duration transpiring between the interrogation and the reply. Based on the durations measured for at least three of the locators, the central computer (16) uses a multilateration

### U.S. Pat. No. 5,929,777

### Inventor: Kevin T. Reynolds

### Issue Date: Jul. 27, 1999

A personal infared beacon unit capable of being worn as an adornment of clothing, incorporated into a part of a person's attire, or embodied within a personal pager, a cellular phone or a 2-way data device. The beacon unit may be in communication with an established network and may be activated externally by a locator signal, or internally by activation of an emergency button. Upon activation , the beacon unit emits coded timed infared bursts in coherent beams, and when the beams are detected, they may be decoded visually or with a decoding device to provide the identity and location of the user.

### SUMMARY OF THE PRESENT INVENTION

The present invention relates generally to location detection systems and, more specifically, to a system including a main terminal for monitoring a specific area such as a mall or park and individual tracking bracelets retained by individuals within the monitored area whereby, upon engaging the activation unit, the main unit can obtain the location of any one of the tracking bracelets and thereby determine the location of the individual.

A primary object of the present invention is to provide a system for locating an individual that will overcome the shortcomings of prior art devices.

Another object of the present invention is to provide a system for locating an individual within a predefined area having a tracking bracelet on their person.

A further object of the present invention is to provide a system for locating an individual that is able to be remotely engaged by an activation unit to initiate a location mode for determining the location of a tracking bracelet.

A yet further object of the present invention is to provide a system for locating an individual wherein the main terminal is able to determine the location of a tracking bracelet within the predetermined area upon either manual activation or upon receipt of a location request signal from an activation unit.

A still further object of the present invention is to provide a system for locating an individual wherein the activation unit includes a selectively covered activation button thereby preventing accidental activation.

An even further object of the present invention is to provide a system for locating an individual wherein an audible alarm is activated on exiting the monitored area of the tracking bracelet or activation unit.

A still further object of the present invention is to provide a system for locating an individual wherein the tracking bracelets are in the form of a lockable bracelet pin or other unobtrusive device, each tracking unit being assigned a unique identification number.

A further object of the present invention is to provide a system for locating an individual wherein the activation units are in the form of a necklace, bracelet pin or hand held unit, each activation unit being assigned a unique identification number.

A yet further object of the present invention is to provide a system for locating an individual wherein security personnel would be in constant contact with the main computer via wireless communication devices for aiding in locating a child wearing a tracking unit.

Another object of the present invention is to provide a system for locating an individual that is simple and easy to use.

A still further object of the present invention is to provide a system for locating an individual that is economical in cost to manufacture.

Additional objects of the present invention will appear as the description proceeds.

A system for locating an individual is disclosed by the present invention. The system includes a main unit for monitoring a predetermined area, a plurality of tracking units having a unique identification code and a plurality of activation units paired with a respective one of said tracking units, each pair having a unique identification code. The activation unit includes an activation button that is manually activated by a user upon desiring to determine a location of the tracking unit. Upon activation of the button a location request signal is transmitted to the main unit to determine a position of the tracking unit within the monitored area. The main unit has a plurality of mobile hand held units that are carried by security personnel of the monitored area. The main unit relays a position signal indicating the determined position to the mobile hand held unit to aid in locating the tracking unit. The main unit includes a central station and a plurality of sensors strategically positioned about the monitored area in wireless communication with the central station. Each tracking unit has means for engaging an audible alarm upon passage outside of the monitored area. Each activation unit includes a cover providing selective access to the activation button. Each tracking unit includes an illumination device for generating a visable signal upon receipt of the location signal from the main unit.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWING FIGURES

Various other objects, features and attendant advantages of the present invention will become more fully appreciated as the same becomes better understood when considered in conjunction with the accompanying drawings, in which like reference characters designate the same or similar parts throughout the several views.

FIG. 1 is a perspective view of a mother looking for her child in a crowded mall;

FIG. 2 is a perspective view of a mother contacting security personnel to initiate a locating session for her child in a mall equipped with the system for locating an individual of the present invention;

FIG. 3 is a perspective view of a mother engaging the activation button of the activation unit thereby generating a locating session signal that contacts the main terminal for locating her child in a mall;

FIG. 4 is a front view of the main terminal of the system for locating an individual of the present invention;

FIG. 5 is an enlarged view of a display appearing on the main terminal of the system for locating an individual of the present invention indicating the position of the tracking unit;

FIG. 6 is a perspective view illustrating communication between the components of the system for locating an individual of the present invention;

FIG. 7 is a perspective view of a mother at the main terminal of the system awaiting return of her child by security personnel;

FIG. 8 is a block diagram of the tracking unit of the system for locating an individual of the present invention;

FIG. 9 is a block diagram of the activation unit of the system for locating an individual of the present invention;

FIG. 10 is a block diagram of the mobile handheld unit of the system for locating an individual of the present invention; and

FIG. 11 is a front perspective view of the tracking device of the present invention;

FIG. 12 is a front perspective view of another of the activation unit of the present invention;

FIG. 13 is a front perspective view of another embodiment of the activation unit of the present invention;

FIG. 14 is a perspective view of the mobile hand held unit of the system for locating an individual of the present invention.

### DESCRIPTION OF THE REFERENCED NUMERALS

Turning now descriptively to the drawings, in which similar reference characters denote similar elements throughout the several views, the Figures illustrate the system for locating an individual of the present invention. With regard to the reference numerals used, the following numbering is used throughout the various drawing figures.

| | |
|---|---|
| 10 | mall area |
| 12 | customers within mall area |
| 14 | stores within mall area |
| 16 | parent |
| 18 | child |
| 20 | system for locating an individual of the present invention |
| 22 | security officer |
| 24 | tracking unit |
| 25 | lines indicating illumination of the tracking unit |
| 26 | activation unit |
| 27 | cover of activation unit |
| 28 | activation button |
| 30 | main unit |
| 32 | processor |
| 34 | keyboard |
| 36 | monitor |
| 38 | transmitter/receiver |
| 40 | display of monitor |
| 42 | display of floor plan |
| 44 | illuminated indication of position of tracking unit |
| 46 | legend on floor plan |
| 48 | indicia on floor plan |
| 49 | activation request signal |
| 50 | request signal |
| 52 | location signal |
| 53 | location tracking signal |
| 54 | illumination device |
| 56 | reply signal |
| 58 | processor of tracking unit |
| 60 | power source of tracking unit |
| 62 | memory of tracking unit |
| 64 | receiver of tracking unit |
| 66 | transmitter of tracking unit |
| 67 | mobile hand held unit |
| 68 | processor of mobile hand held unit |
| 70 | power source of mobile hand held unit |
| 72 | memory of mobile hand held unit |
| 74 | transmitter of mobile hand held unit |
| 76 | receiver of mobile hand held unit |
| 78 | display of mobile hand held unit |
| 80 | speaker of mobile hand held unit |
| 82 | processor of tracking unit |
| 84 | power source of tracking unit |
| 86 | memory of tracking unit |
| 88 | transmitter of tracking unit |

### DETAILED DESCRIPTION OF THE PREFERRED EMBODIMENT

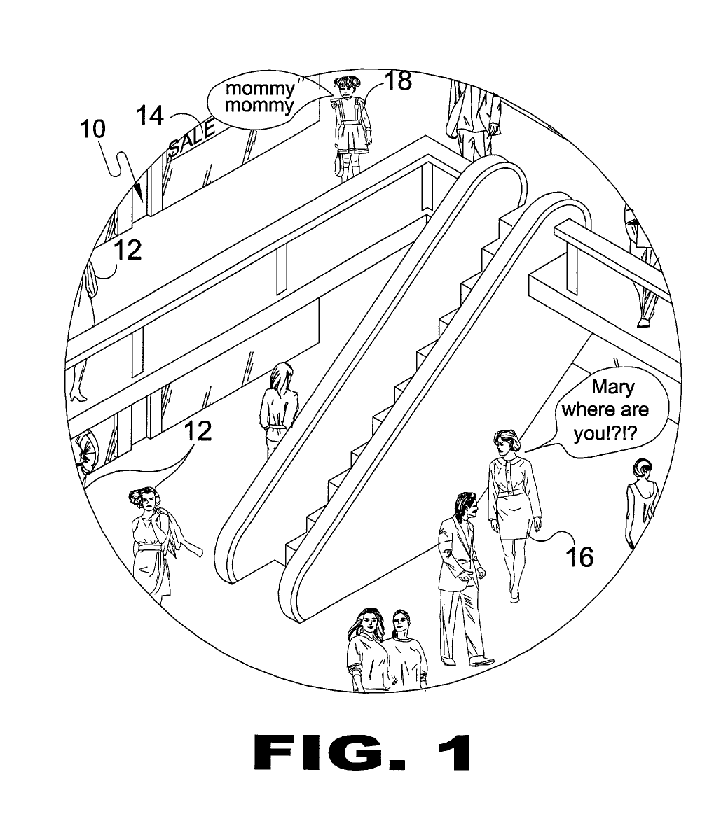

Turning now descriptively to the drawings, in which similar reference characters denote similar elements throughout the several views, FIGS. 1 through 14 illustrate the system for locating an individual of the present invention indicated generally by the numeral 20.

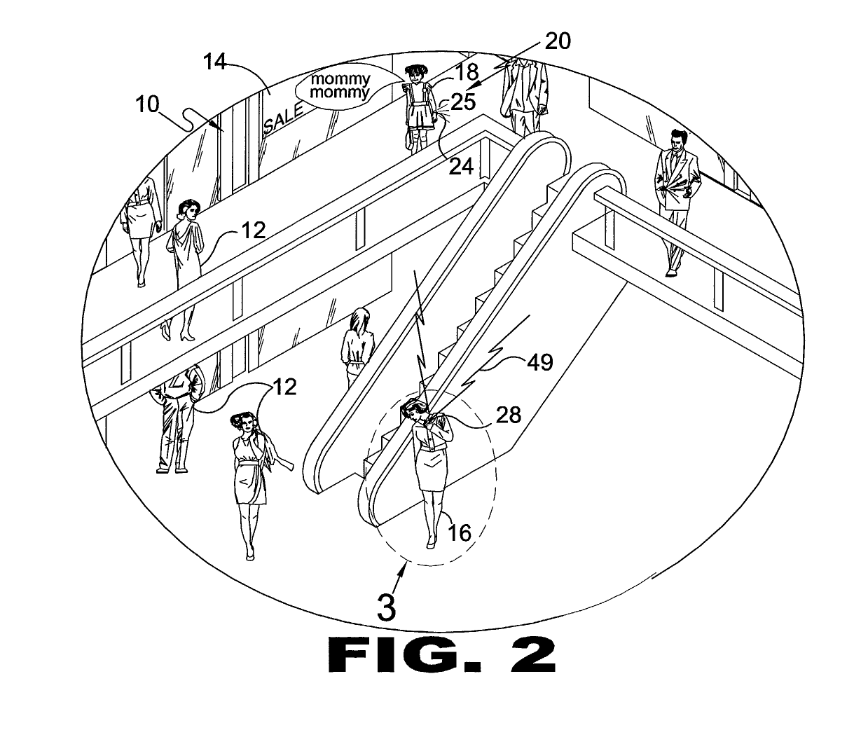

The system for locating an individual 20 is illustrated in FIG. 1 and FIG. 2. As can be seen from these figures, A child 18 has wandered away from her parent 16 within a crowded mall area 10. Upon realizing that the child 18 has wandered off, the parent 16 contacts security personnel 22 to initiate a location session for the missing child 18 by engaging the activation unit 26 carried by the parent 16. The contact of the main unit 30 may be through activation of a button 28 on the activation unit 26 provided to the parent 16 upon registering for the security bracelet 24.

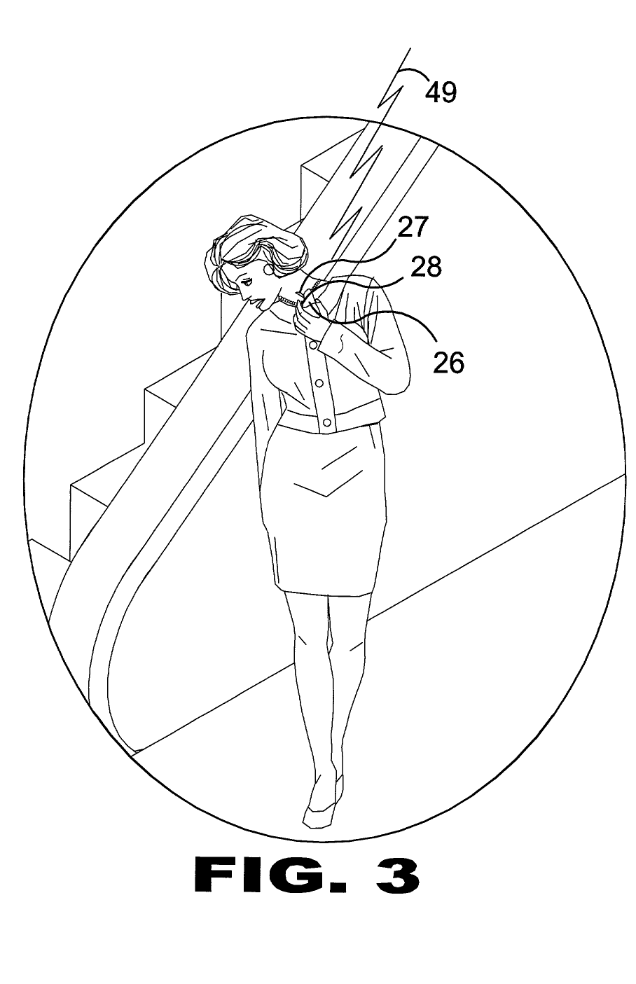

When the activation button 28 is pressed, a wireless signal is transmitted to the main unit 30 including a unique identification code associated with the corresponding tracking unit 24. The main unit 306 is thus able to monitor for the correct tracking unit 24 within the predetermined monitoring area, in this instance the mall area 10. Upon locating the tracking unit within the mall area 10, the operator of the main unit 30 contacts the security officers 22 and directs them to the location of the child 18. FIG. 3 illustrates the parent engaging the activation unit 26 upon detecting the child 18 has wandered off. After activating the button 28, the parent 16 then contacts security personnel 22 to determine the location of the main unit 30 to await the return of the child 18 by security personnel 22 Upon communication with the main unit 30 in determining the location of the tracking unit 24 and child 18, the tracking unit 24 will be caused to illuminate thereby further assisting the security officers 22 in locating the child 18 and tracking unit 24. Illumination of the tracking unit 24 is indicated by the lines labeled with the numeral 25.

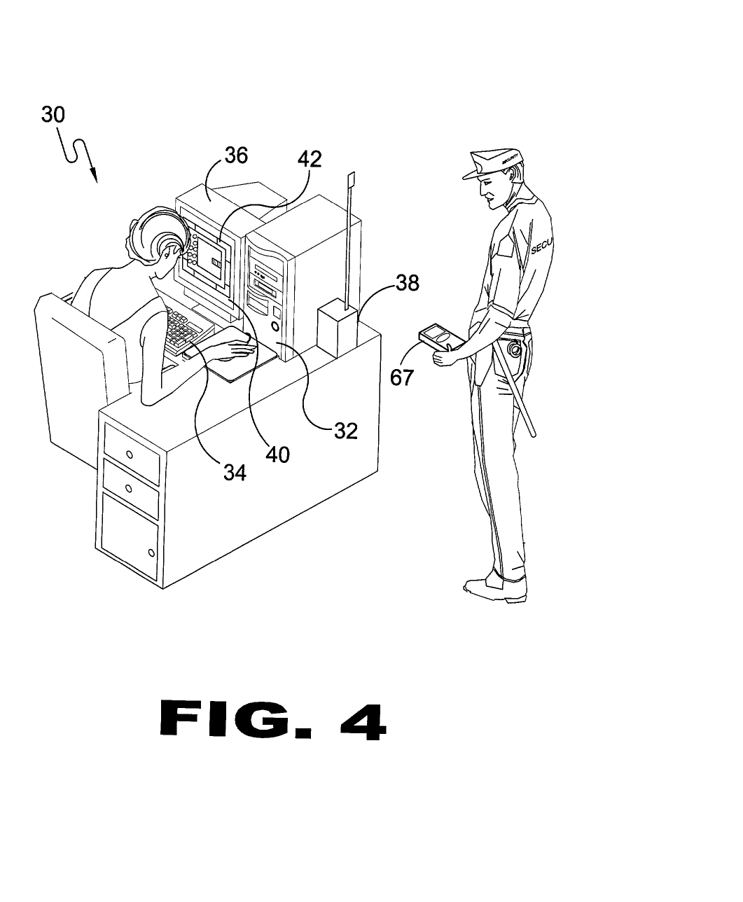

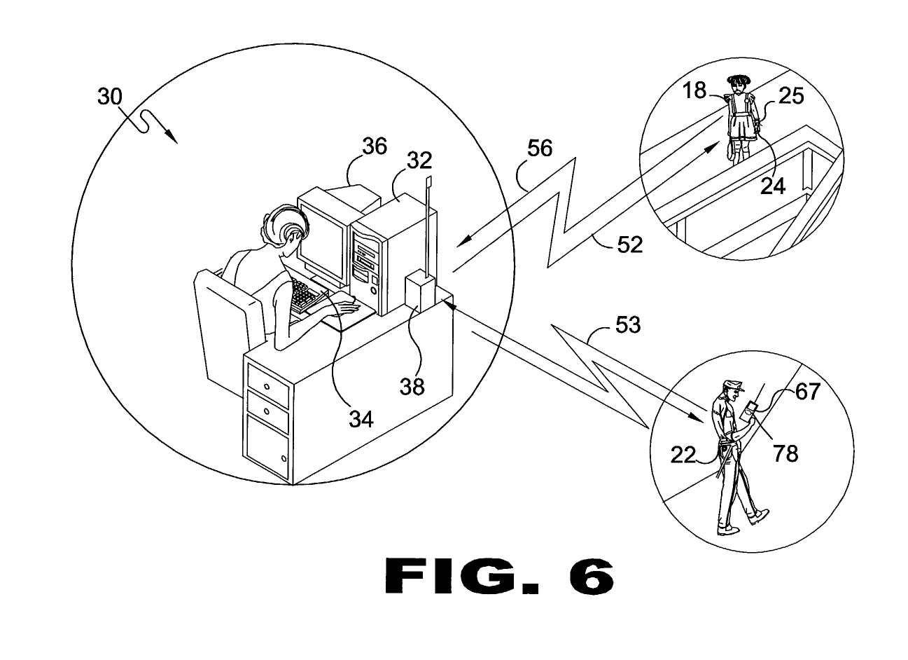

A front view of the main unit 30 is illustrated in FIG. 4 with an enlarged view of a display illustrated in FIG. 6 indicating the location of a selected tracking unit 24. As can be seen from FIG. 4, the main unit 30 includes a processor 32, a keyboard 34, a monitor 36 and a receiver/transmitter 38. The keyboard 34 is provided for data input to the processor 32 such as identification data for each tracking unit 24. The monitor 36 includes a display 40. The display 40 provides a visual floor plan 42 for the area being monitored and is controlled by the processor 32. When the processor 32 is activated to locate a tracking unit 24, upon determining the location of the tracking unit 24, the display is controlled to provide a visual indication of the position of the tracking unit 24 on the displayed floor plan 42.

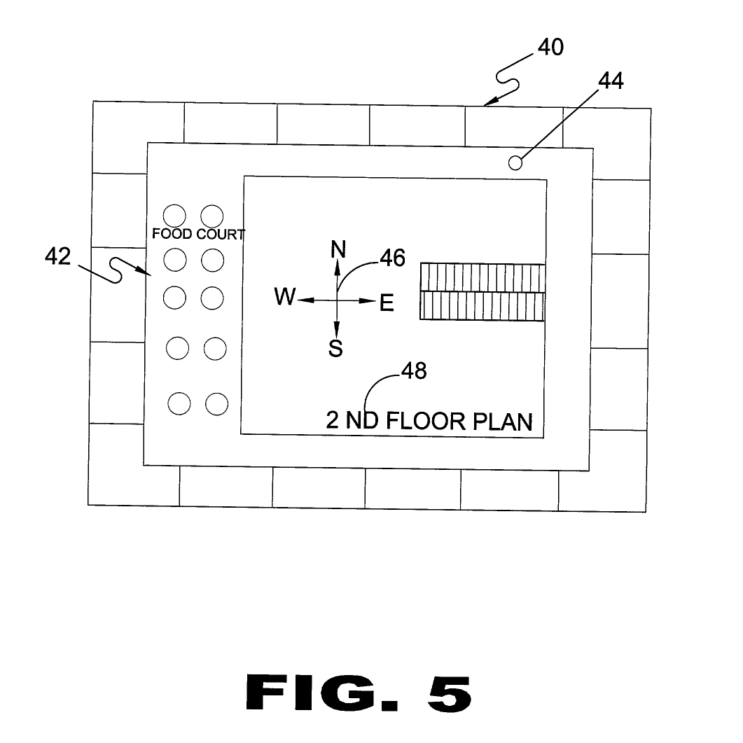

An exemplary floor plan 42 is illustrated in FIG. 5. This figure illustrates a top view of the floor on which the tracking unit 24 is positioned and provides an illuminated indication 44 of the position of the tracking unit 24 with respect to the floor plan 42. The floor plan also includes a legend 46 for orienting the person viewing the display 40 as to the relationship between the display 40 and the actual layout of the area being monitored. Indicia 48 indicating the level or floor of the area being displayed is also provided on the display 40.

A depiction of the communication links established between the elements of the system are illustrated in FIG. 6. As can be seen from this figure, the main unit 30communicates with both the tracking unit 24 and the mobile handheld unit 67. The processor 32 of the main unit 30 is connected to a transmitter/receiver unit 38. Upon activation of the button 28 of the activation unit 26 depicted in FIG. 3, the activation unit 26 generates a location request signal including data representative of the unique identification code associated with the corresponding tracking unit 24. The location request signal is transmitted to the main unit 30 where it is received by the receiver/transmitter 38. The location request signal is indicated by the arrow labeled with the numeral 49 shown in FIG. 3. Upon receipt of this signal, the receiver/transmitter unit 38 forwards the signal to the processor 32. In response to the receipt of the data signal, the processor 32 enters a locate mode. In the locate mode, the processor 32 transmits a location signal to the tracking unit 24. The location signal is indicated by the arrow indicated by the numeral 52. In response to the receipt of the location signal, the tracking unit 24 activates a visual indicator 54 as indicated by the lines labeled with the numeral 25 and transmits a reply signal to the processor 32 including its unique code. The reply signal is indicated by the arrow labeled with the numeral 56. The processor 32 is thus able to match the tracking unit 24 with the activation unit 26 that initiated the location operation. The main unit 30 then determines the location of the tracking unit 24 and relays this information to security personnel to aid their attempts at finding the tracking unit 24.

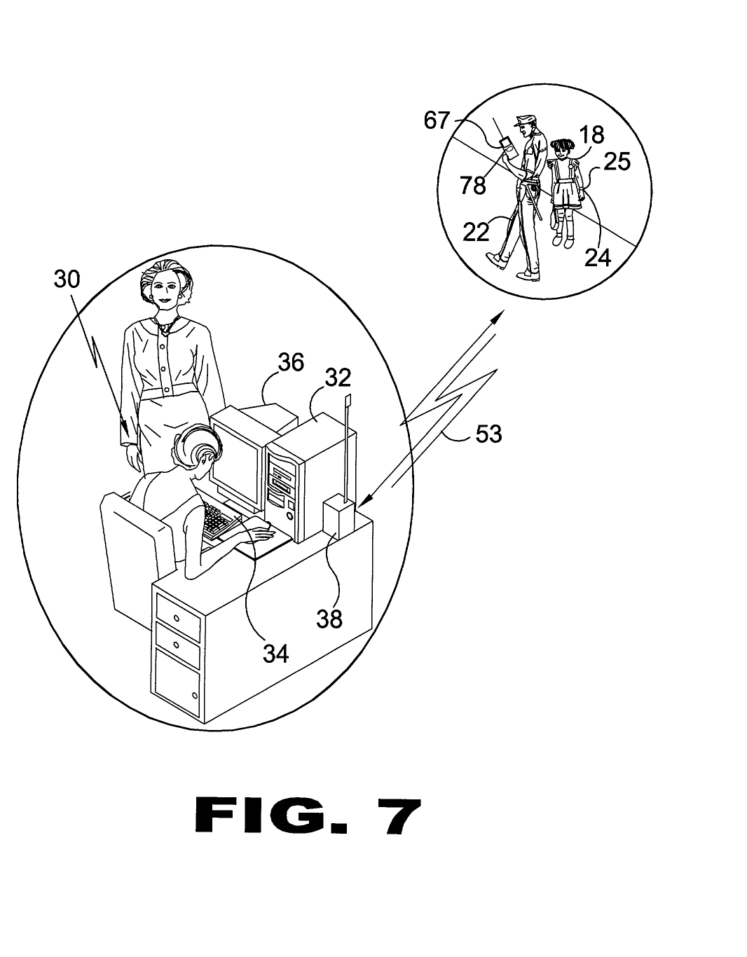

A depiction of the communication links established between the mobile handheld unit 67 and main unit 30 of the system are illustrated in FIG. 7. As can be seen from this figure, the main unit 30 communicates with both the tracking unit 24 and the mobile handheld unit 67. The processor 32 of the main unit 30 is connected to a transmitter/receiver unit 38. In response to the receipt of the location request signal 49 from the activation unit 26 shown in FIG. 3, the processor 32 enters a locate mode. In the locate mode, the processor 32 transmits a location signal to the tracking unit 24. In response to the receipt of the location signal, the tracking unit 24 activates a visual indicator shown by the lines labeled with the numeral 25. The processor 32 is thus able to match the tracking unit 24 with the activation unit 26 that initiated the location operation. The main unit 30 then determines the location of the tracking unit 24 and relays this information to security personnel 22 having a mobile handheld unit 67 with a display 78 of the monitored area showing the location of the tracking unit 24 as shown in FIG. 5.

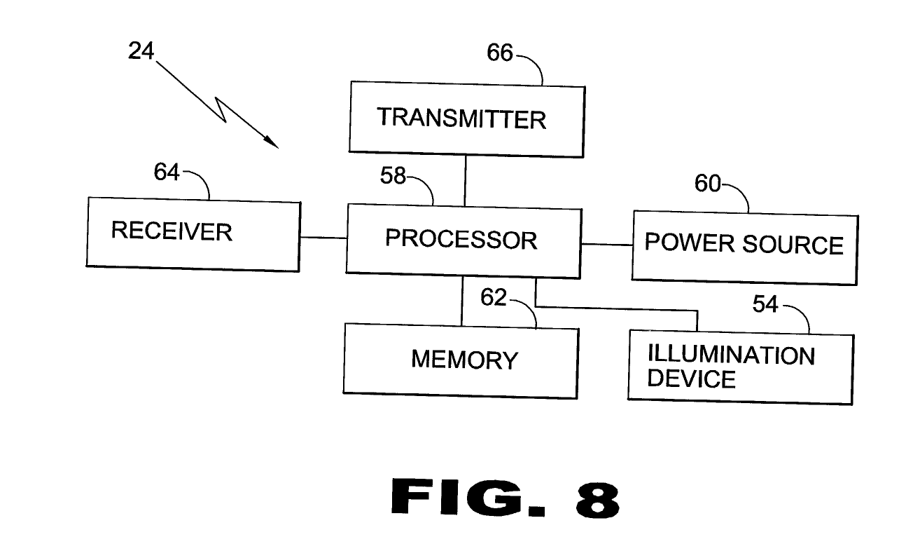

A block diagram of the tracking unit 24 is illustrated in FIG. 8. As can be seen from this figure, the tracking unit 24 includes a processor 58 for analyzing the signals received from the main unit 30. Connected to the processor 58 is a power source 60 for supplying operating power to the components of the tracking unit 24. A memory unit 62 is also connected to the processor 58 for storing the unique identity code of the tracking unit 24 as well as all programs necessary for the operation of the processor 58. A receiver 64 is connected to the processor 58 for receiving location signals transmitted by the main unit 30 and providing the received signals to the processor 58 for analysis. A transmitter 66 is provided for transmitting a reply signal to the main unit 26 including the unique identity code stored in the memory unit 62 under the control of the processor 58. The illumination device 54 is preferably an LED located on an outer side of the tracking unit 24 and is illuminated by the processor 58 upon receipt of the location signal from the main unit 30. The illumination device 54 aids the security personnel in locating the tracking unit 24 by providing a visual signal. When the tracking unit 24 exits the monitored area, a signal transmitted from transmitter 66 is received by sensors located at the borders of the monitored area. In response to receipt of this signal, the main unit 30 controls speakers to generate an audible alarm signal at the exit point of tracking unit 24.

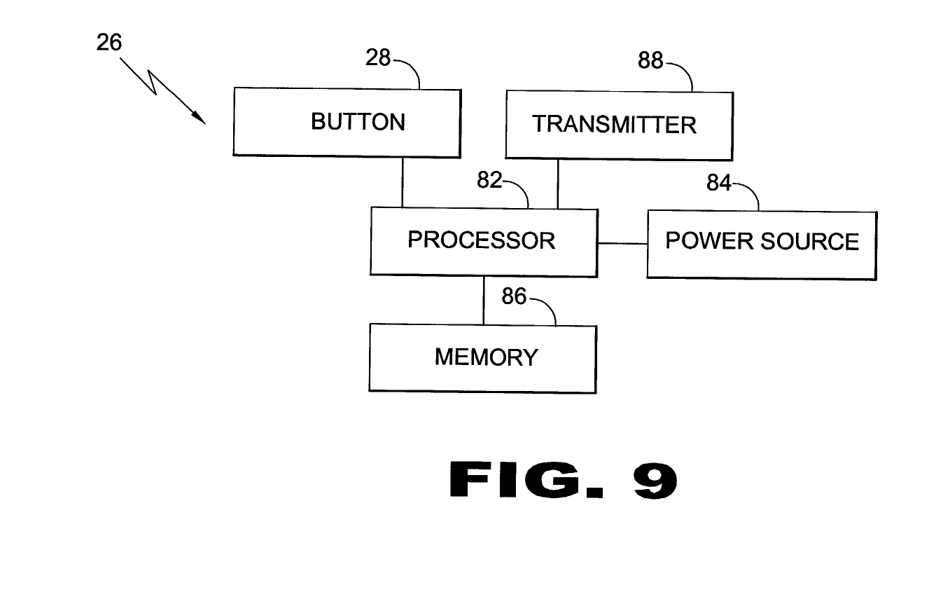

A block diagram of the activation unit 26 is illustrated in FIG. 9. As can be seen from this figure, the activation unit 26 includes an activation button 28 communicating with processor 82 for transmitting the activation request signal 49 to the main unit 30. Connected to the processor 82 is a power source 84 for supplying operating power to the components of the activation unit 26. A memory unit 86 is also connected to the processor 82 for storing the unique identity code of the activation unit 26. A transmitter 88 is provided for transmitting an activation request signal to the main unit 30 including the unique identity code stored in the memory unit 86 under the control of the processor 82. When the activation unit 26 exits the monitored area, a signal transmitted from transmitter 88 is received by sensors located at the borders of the monitored area. In response to receipt of this signal, the main unit 30 controls speakers to generate an audible alarm signal at the exit point of the activation unit 26.

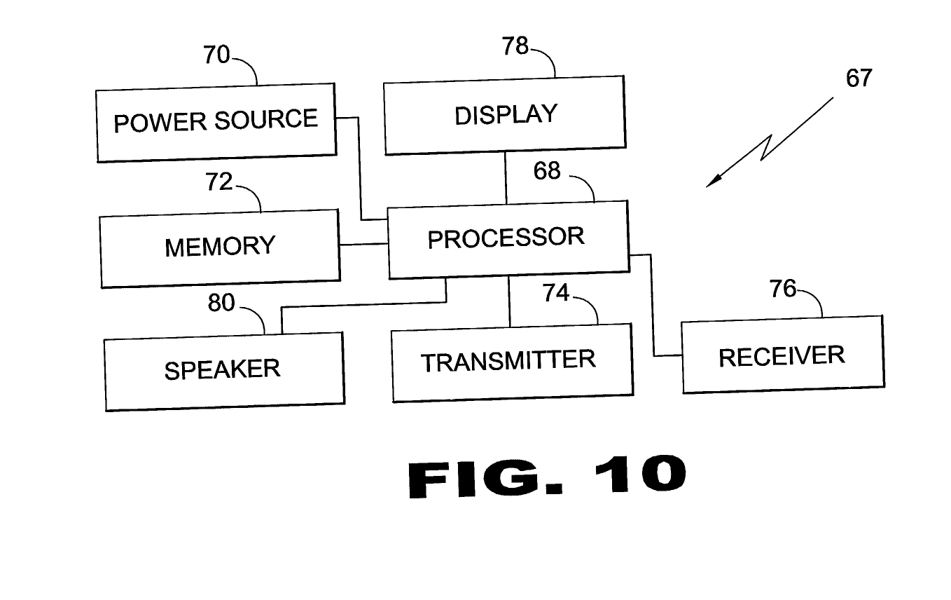

A block diagram of the mobile hand held unit 67 is illustrated in FIG. 10. As can be seen from this figure, the mobile hand held unit 67 includes a processor 68 for controlling operation of the hand held unit 67. Connected to the processor 68 is a power source 70 for supplying operating power to the components of the hand held unit 67. A memory unit 72 is also connected to the processor 68 for storing the transmitted unique identity code of the tracking unit 24 during a tracking session as well as all programs necessary for the operation of the processor 68. A display 78 may be provided on the hand held unit 67 for displaying a floor plan of the area being monitored along with an indicator for informing the user as to the location of the tracking unit 24. A receiver 76 is connected to the processor 68 for receiving control signals transmitted by the main unit 30 and providing the received signals to the processor 58 for analysis and controlling the display 78, as can be seen in FIG. 7. A speaker 80 is also connected to the processor 68. When the tracking unit 26 exits the monitored area, a signal is transmitted from sensors located at the borders of the monitored area. This signal is received by the receiver 76 and provided to the processor 68. In response to receipt of this signal, the processor 68 controls the speaker 80 to generate an audible alarm signal.

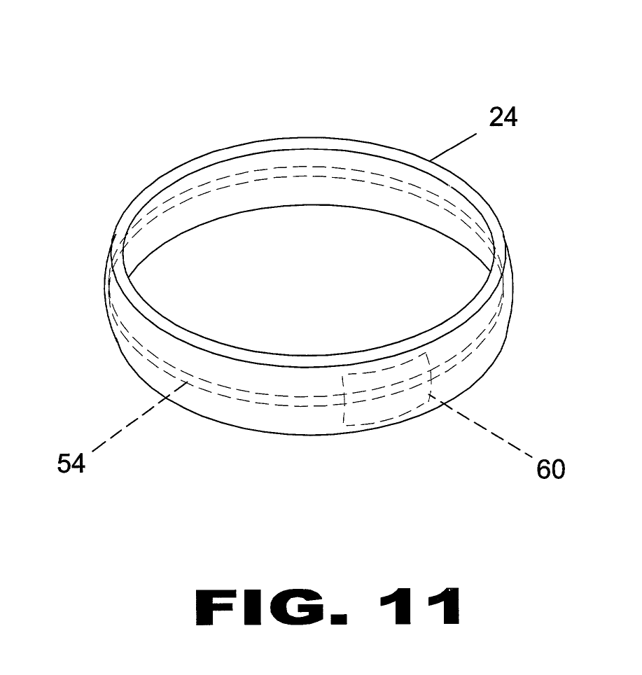

FIG. 11 provides a perspective view of one possible construction of the tracking unit 24. The tracking unit 24 is of a size able to be unobtrusive to the user and is readily fixed to an individual or placed into a purse or pocket. The tracking unit 24 includes the power source 60 and illumination device 54 along with the transmitter, receiver, processor and memory as shown and described in FIG. 8.

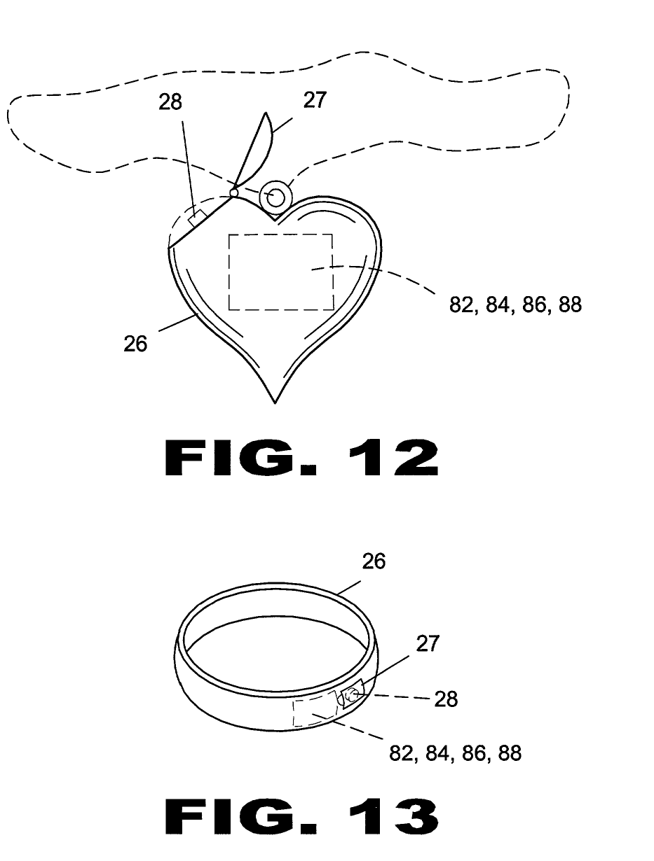

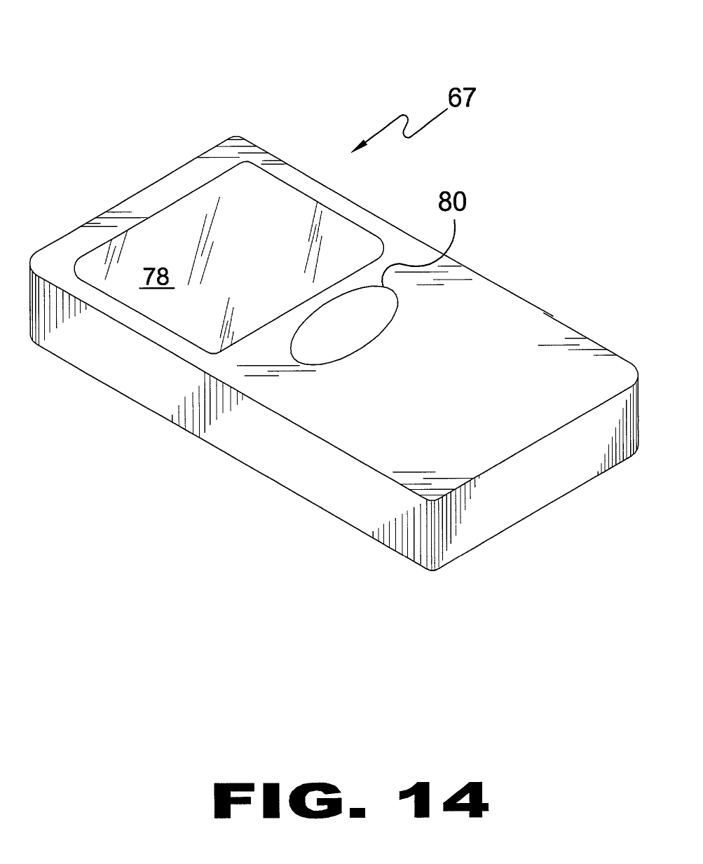

FIG. 12 and FIG. 13 provide a perspective view of the alternate forms of the activation unit 26. The activation unit 26 can be constructed in the form of jewelry. FIG. 12 shows the device constructed as a locket that can be worn around the neck. While FIG. 13 shows the activation unit 26 constructed as a bracelet that can be worn on the wrist of the parent. the size of the activation unit is unobtrusive to the user and fits readily into a purse or pocket. The activation unit 26 includes the activation button 28 for generating the activation request signal 49 that is transmitted to main unit 30 to enter a locate mode and initiate locating the tracking unit 24. A cover 27 is positioned above the activation button 28 and provides selective access to the activation button 28. The cover 27 thus prevents accidental activation of the tracking activation button 28.

FIG. 14 provides a perspective view of the mobile hand held unit 67. The hand held unit 67 is of a size able to unobtrusive to the user and fit readily into a purse or pocket. The hand held unit 67 includes the activation button 28 for controlling the main unit 26 to enter a locate mode and initiate locating the tracking unit 24. The display 78 is also provided on the hand held unit 30 so that the user may be provided a visual indication of the location of the tracking unit 24. A cover 80 is positioned above the activation button 28 and provides selective access to the activation button 28. The cove 80 thus prevents accidental activation of the tracking button 28. The speaker 84 is also provided on the hand held unit 30. The speaker 84 is controlled to generate and audible signal when the hand held unit 30 exits the monitored area.

The operation of the system for locating an individual 10 will now be described with reference to the figures. In operation, the system for locating an individual 10 is installed within an area to be monitored. The installation of the system includes strategically positioning sensors about the monitored area. The sensors are able to detect the tracking units 24 and activation unit 26. The sensors are also able to communicate through wireless communication channels with the main unit 30 and mobile handheld units 67. The main unit 30 is located in a central area and is monitored by an operator. Security personnel 22 are positioned throughout the monitored area and are in communication with the operator at the main unit 30 using mobile handheld units 67. Each tracking unit 24 and activation unit 26 are paired together. Each tracking unit 24 and activation unit 26 pair are programmed with a unique identification code. Each identification code is also stored within the processor 32 of the main unit 30 and associated with the respective tracking unit and activation unit pair. When a user wishes to monitor the location of a child or another person, they check out a tracking unit 24 and activation unit 26 pair from a central office. General information concerning the user checking out the tracking unit 24 and activation unit 26 pair are input to the main unit 30 using the input device 34, preferably a keyboard. However, the input device 34 may be any device connectable to the processor 32 and able to input data to the processor 32. At this time the user's may go about their business within the monitored area.

As the user shops, it becomes possible that a child with the user may wander off when the user is distracted or not watching the child closely. Upon detecting that the child has wandered off, the user will activate the activation unit 26 by pressing the activation button 28. When the activation button 28 is activated, the activation unit 26 generates a location request signal including data representative of the unique identification code associated with the corresponding tracking unit 24. The location request signal 49 is transmitted to the main unit 30 where it is received by the receiver/transmitter 38. Upon receipt of this signal, the receiver/transmitter unit 38 forwards the signal to the processor 32. In response to the receipt of the data signal, the processor 32 enters a locate mode. In the locate mode, the processor 32 transmits a location signal 52 to the tracking unit 24. In response to the receipt of the location signal 52, the tracking unit 24 activates a visual indicator 54 to illuminate and provide a visual indication of the activated tracking unit 24 and transmits a reply signal 56 to the processor 32 including its unique code. The processor 32 is thus able to match the tracking unit 24 with the activation unit 26 that initiated the location operation. The main unit 26 then determines the location of the tracking unit 24 via communication with the strategically positioned sensors located throughout the monitored area. Upon determination of the position of the tracking unit 24, the operator of the main unit 26 relays this information to security personnel having mobile handheld unit 67 to aid their attempts at finding the tracking unit 24.

The sensors are also positioned about the periphery of the monitored area 10. The sensors constantly monitor for the presence of tracking units 24 and activation unit 26 passing outside of the monitored area. Upon detection of a tracking unit 24 or activation unit 26 passing by the sensors and outside of the monitored area, the sensors will transmit a signal to the main unit 30 and mobile handheld units 67 activating speakers to generate an audible signal. The audible signal will alert persons in the vicinity of the tracking unit 24 or activation unit 26 that it has exited the monitored area.

The system of the present invention is also useful for monitoring numerous other areas other than the example used herein. Examples of such additional monitoring areas include, playgrounds, amusement parks, nursing facilities and hospitals.

From the above description it can be seen that the system for locating an individual of the present invention is able to overcome the shortcomings of prior art devices by providing a system for locating an individual including a main unit which is able to monitor a predefined area for individuals retaining a tracking unit on their person and be remotely activated by an activation unit to initiate a location mode for determining the location of the tracking unit. The activation unit includes a selectively covered activation button thereby preventing accidental activation and the tracking units are in the form of a lockable bracelet or pin, each tracking unit being assigned a unique identification number. The system for locating an individual provides for security personnel located throughout the monitored area to be in constant contact with the main computer via wireless communication devices for aiding in locating a child. Furthermore, the system for locating an individual of the present invention is simple and easy to use and economical in cost to manufacture.

It will be understood that each of the elements described above, or two or more together may also find a useful application in other types of methods differing from the type described above.

While certain novel features of this invention have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed is new and desired to be protected by Letters Patent is set forth in the appended claims:

1. A systems for locating an individual, said system comprising:
a) a main unit for monitoring a predetermined area;
b) a tracking unit having a unique identification code;
c) an activation unit having an identification code corresponding to the tracking unit and an activation button, said activation button being manually activated by a user upon desiring to determine a location of the tracking unit, wherein activation of the activation button, a location request signal is transmitted to said main unit activating said main unit to determine a position of said tracking unit within the monitored area; and
d) a mobile hand held unit in selective communication with the main unit, said main unit relaying a position signal indicating the determined position to said hand held unit thereby aiding in locating said tracking unit.

2. The system as recited in claim 1, wherein said main unit includes a central station, said central station including a receiver for receiving said location request signal, a processor for analyzing said location request signal and determining the position of said tracking unit and a transmitter for relaying the position to said mobile hand held unit.

3. The system as recited in claim 2, wherein said main unit further includes a plurality of sensors strategically positioned about the monitored area, said sensors being in wireless communication with said main unit for aiding in determining the position of said tracking unit.

4. The system as recited in claim 3, wherein at least one of said plurality of sensors are positioned about a periphery of the monitored area for detecting passage of any of said tracking unit and activation unit outside of the monitored area.

5. The system as recited in claim 4, wherein said monitoring area having a speaker induces said speaker by at least one sensor activating said speaker to generate an audible alarm signal upon detecting passage of said tracking unit outside of the monitored area.

6. The system as recited in claim 4, wherein said mobile hand held unit includes a speaker, said at least one sensor activating said speaker to generate an audible alarm signal upon detecting passage of said tracking unit and/or said activation unit outside of the monitored area.

7. The system as recited in claim 1, wherein said activation unit includes a transmitter for transmitting the location request signal to said main unit.

8. The system as recited in claim 1, wherein said mobile hand held unit includes a receiver for receiving a location signal from the main unit.

9. The system as recited in claim 8, wherein said hand held unit further includes a display for displaying a floor plan of the monitored area and indicating a position of said tracking unit on the floor plan in response to receipt of the position signal from said main unit.

10. The system as recited in claim 1, wherein said activation unit further includes a cover for providing selective access to said activation button thereby minimizing the possibility of inadvertent activation.

11. The system as recited in claim 2, wherein said tracking unit includes a receiver for receiving a location signal from said main unit and a transmitter for transmitting a reply signal including data indicative of the unique identification code of said tracking unit to said main unit.

12. The system as recited in claim 11, wherein said tracking unit further includes an illumination device, whereby said illumination device is activated to generate a visible signal upon receipt of the location signal.

13. The system as recited in claim 4, wherein said system further includes a plurality of tracking units and a plurality of activation units, each tracking unit being paired with a respective one of said activation units wherein the tracking unit and activation unit of each pair is assigned a unique identification code.

14. The system as recited in claim 13, wherein said main unit stores information regarding each pair of tracking and activation units including the unique identification code for each pair.

15. The as recited in claim 14, wherein each of said tracking units includes at least one sensor activating said monitoring area speaker to generate an audible alarm signal upon detecting passage of said tracking unit outside of the monitored area.

16. The as recited in claim 14, wherein each of said activation units includes at least one sensor activating said monitoring area speaker to generate an audible alarm signal upon detecting passage of said tracking unit outside of the monitored area.

17. The system as recited in claim 14, wherein each of said activation units includes a transmitter for transmitting the location request signal to said main unit.

18. The system as recited in claim 17, wherein each of said mobile hand held units further includes a display for displaying a floor plan of the monitored area and indicating a position of said tracking unit on the floor plan in response to receipt of the position signal from said main unit.

19. The system as recited in claim 17, wherein each of said activation units further includes a cover for providing selective access to said activation button thereby minimizing the possibility of inadvertent activation.

20. The system as recited in claim 14, wherein each of said tracking units includes a receiver for receiving a location signal from said main unit and a transmitter for transmitting a reply signal including data indicative of the unique identification code of said tracking unit to said unit.

21. The system as recited in claim 20, wherein each of said tracking units further includes an illumination device, whereby said illumination device is activated to generate a visible signal upon receipt of the location signal.
